(19) United States
(12) Patent Application Publication
(10) Pub. No.: US 2014/0316751 A1
(43) Pub. Date: Oct. 23, 2014

(54) SYSTEM AND METHOD OF GENERATING GEOMETRY OF A SWEPT VOLUME OF A SPUN TOOL

(71) Applicants: Peter Philip Lonsdale Nanson, Cambridge (GB); Richard Charles Collins, Cambridge (GB); Jianwei Zhou, Cambridge (GB)

(72) Inventors: Peter Philip Lonsdale Nanson, Cambridge (GB); Richard Charles Collins, Cambridge (GB); Jianwei Zhou, Cambridge (GB)

(73) Assignee: SIEMENS PRODUCT LIFECYCLE MANAGEMENT SOFTWARE INC., Plano, TX (US)

(21) Appl. No.: 13/864,745

(22) Filed: Apr. 17, 2013

(51) Int. Cl. G06F 17/50

(52) U.S. Cl. CPC G06F 17/5009
USPC 703/2

(57) ABSTRACT

A method includes receiving a representation of a spun tool and receiving a path for the spun tool. The method also includes calculating a profile of the spun tool and simulating movement of the spun tool over the path. The method includes determining critical positions along the path at which the composition of the profile of the spun tool changes based on the path, and re-calculating the composition of the profile of the spun tool for each side of a critical position. The method further includes re-calculating the shape of the profile of the spun tool at non-critical positions of the path. The method further includes determining a volume defined by moving the spun tool along the path between a first critical position and a second critical position, changing the profile of the spun tool at each critical position, and calculating a total volume based on the path.

### TECHNICAL FIELD

The present disclosure is directed, in general, to computer-aided design, visualization, and manufacturing systems, product lifecycle management (“PLM”) systems, and similar systems, that manage data for products and other items (collectively, “Product Data Management” systems or PDM systems).

### BACKGROUND OF THE DISCLOSURE

PDM systems manage PLM and other data. Improved systems are desirable.

### SUMMARY OF THE DISCLOSURE

Various disclosed embodiments include a data processing system, method, and computer readable medium. A method for product data management includes receiving a representation of a spun tool and receiving a path for the spun tool. The method also includes calculating a profile of the spun tool and simulating movement of the spun tool over the path. The method further includes determining critical positions along the path at which the composition of the profile of the spun tool changes based on the path, and re-calculating the composition of the profile of the spun tool for each side of a critical position. The method further includes re-calculating the shape of the profile of the spun tool at non-critical positions of the path. The method further includes determining a volume defined by moving the spun tool along the path between a first critical position and a second critical position, changing the shape of the profile of the spun tool as it moves along the path, changing the composition of the profile at each critical position, and calculating a total volume based on the path. The method also includes storing the total volume in a memory associated with the data processing system.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a data processing system in which an embodiment can be implemented;

FIG. 2 illustrates an example of a spun profile and 3D path illustrating motion of a tool;

FIG. 3 illustrates surfaces generated from sweeping a spun tool; and

FIG. 4 illustrates a flowchart of a process in accordance with disclosed embodiments.

### DETAILED DESCRIPTION

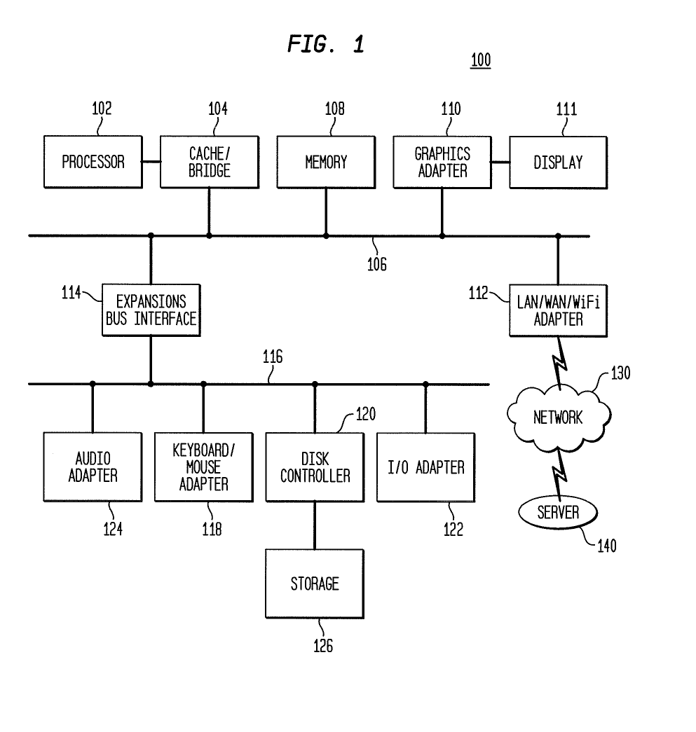

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Simulating removal of material by a spinning tool is used for processes such as milling or turning. One challenge is the ability to create a precise boundary-representation (b-rep) model representing a volume produced by moving the spinning tool along a general three dimensional (3D) path. Disclosed embodiments include systems and methods for product data management to create a precise b-rep model.

FIG. 1 illustrates a block diagram of a data processing system in which an embodiment can be implemented, for example as a PDM system particularly configured by software or otherwise to perform the processes as described herein, and in particular as each one of a plurality of interconnected and communicating systems as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

When sweeping a solid tool body, the shape being actually produced is the trace of the tool body's varying outlines along a path that the tool body traverses. For a three dimensional (3D) path, it is desirable to be able to evaluate a non-projected outline anywhere in the range of the path.

When a path is curved in 3D, the outlines of the tool body viewed in the path tangent direction can change shape topologically. A challenge involved in solid sweeping is handling topological changes in the outlines. In various embodiments, handling topological changes in the outlines is based on identifying critical positions where the topology of the sweep will change. The path may be subdivided at these critical positions to produce sections that will generate a substantially constant topology in the resulting sweep. In various embodiments, the 3D path may be divided into one or more monotonically rising, monotonically falling, or flat sections.

In various embodiments, the tool comprises a revolved solid. As such, the types of surfaces that are analyzed are fundamentally spun surfaces and planes.

A spun surface may be defined by:

R(u, v)=Z(u)+(C(u)−Z(u))cos(v)+A×(C(u)−Z(u))sin(v).

where C(u) is a profile curve, Z(u) is a projection of C(u) onto a spin axis and A is a spin axis direction. Denoting X, Y, and A as directions of a local coordinate frame, the spun profile curve may be expressed as:

C(u)=P₀+p(u)X+q(u)Y+r(u)A.

As a property of the sweep operation, this expression holds anywhere along the path. The directions X, Y, and A vary as the local coordinate frame moves along the path. If t(s) is the tangent of the path at parameter s and n(u, v) the normal on the spun surface, then contour points of the spun surface satisfy

t(s)·n(u, v)=0.

In the local coordinate frame, the spun surface can be represented as

Rᵤ(u, v)=(p′ cos(v)−q′ sin(v))X+(p′ sin(v)+q′ cos(v))Y+r′A,

and

Rᵥ(u, v)=(−p sin(v)−q cos(v))X+(p cos(v)−q sin(v))Y.

The equation for contour points may be expressed as

t(s)·Rᵤ(u, v)×Rᵥ(u, v)=0.

Denoting t(s)=αX+βX+ρA and substituting into the equation above, the system can obtain

a sin(v)+b cos(v)=c.

where coefficients are given by

a=(βp−αq)r′, b=(αp+βq)r′, c=ρ(pp′+qq′).

Using half angle mapping

$$σ = tan ( \frac{v}{2} ) ,$$

the system can obtain

(b+c)σ²−2aσ−(b−c)=0,

a simple quadratic equation in σ for the contour points for fixed profile parameter u and path parameter s. There are two solutions in general which indicate two contour lines on a spun surface, one left and one right with respect to the spin axis.

The discriminant of the quadratic equation for contour points may be expressed as

Δ=a²+b²−c².

When the discriminant is negative, there will be no solution for contour points and the condition may be signaled as a failing condition.

The quadratic equation has two significant cases of degeneracy. The first is when b=c=0 and a ≠ 0. This can easily happen at places where p(u)=0 and t(s)=αX. The second case is when a=b=c=0. The quadratic equation can still be solved as a limiting case by taking left-most and right-most extreme points. The direction between left and right can be defined by

A×t=αY−βX,

A point on the spun surface may be projected onto this direction as

(R(u, v)−P₀)·(A×t)=α(p sin(v)+q cos(v))−β(p cos(v)−q sin(v)).

The left-most and right-most extreme points may be obtained by zero derivative points with respect to parameter v. They may be determined by the following equation

(αp+βq)cos(v)−(αq−βq)sin(v)=0.

For a profile in a plane through the spin axis, it may be assumed that p(u)≡0, which leads to

Δ=(α²+β²)q²r′²−p²q²q′²=q²(r′²−p²(q′²+r′²)).

If the profile is further simplified to a line with q′²+r′²=1, then the spun surface will be a cone and the discriminant becomes

Δ=q²(r′²−p²).

this confirms there will be no contour points on the cone if the path tangent is steeper than the slope of the cone. This is a simple but important observation. It shows the problem of disappearing contour and hence topological changes in the sweep can also happen for a tool body of convex edges, and that the discriminant can indicate where such topological changes occur.

If the spun surface is a cylinder, then r′(u)≡1 and the discriminant will not be negative.

If the spun surface is a torus, then the profile curve for a torus may be expressed as:

C(u)=Pₒ+0·X+(λ+μ cos(u))Y+((c−P₀)·A+μ sin(u)A).

where c is the center of the circle. Thus, the coordinates of profile in the local coordinate chart are:

p(u)≡0.

q(u)=λ+μ cos(u).

r(u)=(c−P₀)·A+μ sin(u).

For path tangent t(s)=αX+βY+ρA:

a=a(u)=(βp−αq)r′=−α·(λ+μ cos(u))·μ·cos(u).

b=b(u)=(αp+βq)r′=β·(λ+μ cos(u))·μ cos(u).

c=c(u)=ρ(pp′+qq′)=−ρ·(λ+μ cos(u))·μ sin(u).

Preferably, a contour point at spin angle v satisfies

a sin(v)+b cos(v)=c.

The quadratic equation derived from the above equation for σ=tan(v/2) has discriminant

Δ=a²+b²−c²=q²(u)μ²((α²+β²)cos²(u)−ρ² sin²(u))

for a torus. Thus

Δ=q²(u)μ² sin(θ+u)sin(θ−u)

where cos(θ)=ρ is known for the given path tangent.

If the torus is a donut torus, then q(u)=λ+μ cos(u)>0 and μ>0. Let

$$θ ∈ [ 0 , π ] , u ∈ [ - \frac{π}{2} , \frac{2 π}{2} ] .$$

Then Δ≧0 if and only if −θ₀≦u≦θ₀ or π−θ₀≦u≦π+θ₀. This provides a range within which profile contour points exist.

The equation for contour points on a donut torus is also simplified to

(α sin(v)−β cos(v))cos(u)=ρ sin(u).

This equation can be solved easily for either fixed u or v values. If u is known, then v is obtained from the quadratic equation. If v is known, then u can be solved by taking arctangent. Note the singularity case of ρ=0.

The singularity case may be absorbed by a change of parameterization for the contour curve, at least when spinning the top-right quarter of the profile circle. The parameter space may be divided into three regions, two triangular ones at left and right sides and a trapezium one in the middle.

The region on the left side may be defined by a family of parameter space lines

$$u + τ v = δ , u , δ ∈ [ 0 , \frac{π}{2} ] .$$

The coefficient τ may be fixed at any value as long as the families of lines properly divide the parameter domain without crossing each other.

The region on the right side may be defined by a family of parameter space lines

$$v - π = 2 τ ( u - δ ) , u , δ ∈ [ 0 , \frac{π}{2} ] .$$

Finally, the family of parameter space lines for the middle trapezium region may be defined by

$$v - δπ = 2 τ ( 2 δ - 1 ) ( u - \frac{π}{2} ) , u ∈ [ 0 , \frac{π}{2} ] , δ ∈ [ 0 , 1 ] .$$

Surfaces capping a revolved tool are often special spun surfaces with singularities, such as planes and spheres, which typically raise the failure condition of a negative discriminant. Their outline is not always contour points mapped one-to-one from their spun profile curves.

Planar caps of a spun surface are just circular discs with normal parallel to the spin axis. When sweeping such a planar cap, the edge of the disc is effectively split by the contour points on the spun surface. Preferably, only the portion forming part of the outline of the revolved solid bounded by the spun surface should be swept, and may be anything between the whole circle to just a single point on the circle.

Given the profile parameter u for the planar cap, the contour points of the spun surface can be calculated using the formulae described above. Thus the circle of the disc may be naturally divided into a leading portion and a trailing portion with respect to the path tangent direction. If the disc is taken as the planar cap face for the revolved solid of the spun surface so that the disc is oriented with face normal of the solid, then the leading portion may be swept if the normal is pointing away from the path direction, and the trailing portion may be swept otherwise.

One conclusion that may be drawn from examining the sweeping of planar caps is that it may be preferable to split the path to catch any undulation with respect to the spin axis. The path may be split into segments of one or more rising, falling or flat categories.

The above procedure for sweeping discs can be applied to certain configurations of surface caps, such as cones and spheres, as long as the portion trimmed by the spun surface is effectively flat. Consider a shallow cone capping for example. If the sweep direction is always steeper with respect to the spin axis than the lines defining the cone, then the interior of the cone capping is never seen. Therefore, the sweep trace of such a shallow cone capping is the same as one produced by a corresponding disc. Moreover, any surface capping contained within such a shallow cone capping has the same property.

In addition, the above procedure for sweeping discs can be applied to generating surfaces swept out by sharp edges of the spun tool. For example, if the tool includes a cylinder joined to a coaxial cone, then the sharp edge between the cone and the cylinder may sweep out a disc surface.

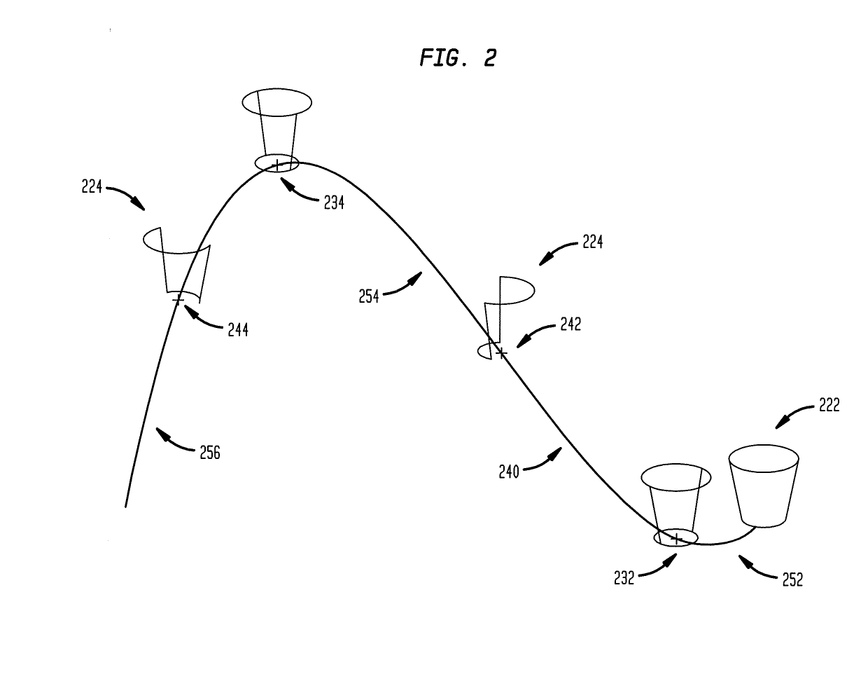

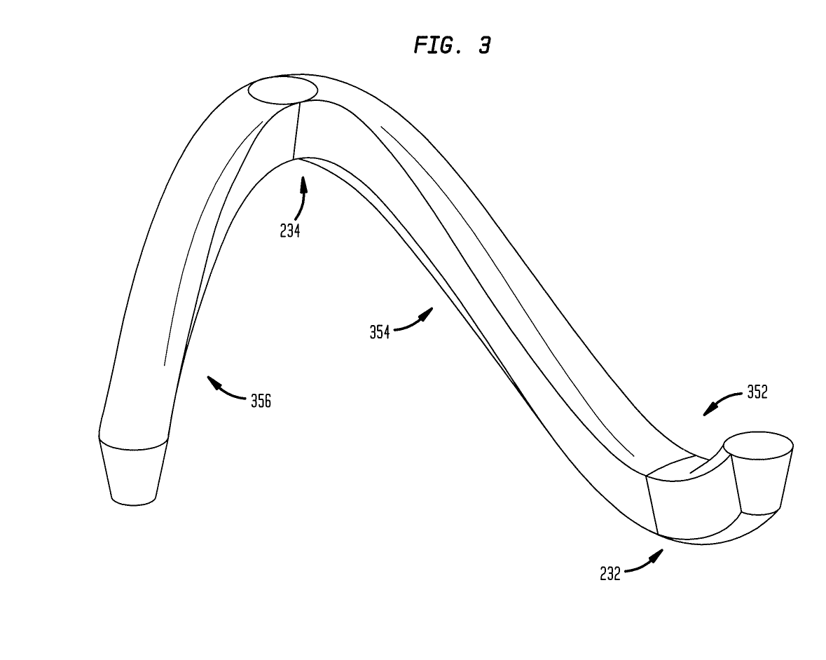

FIG. 2 illustrates an example of a spun profile and 3D path illustrating motion of a tool, and FIG. 3 illustrates surfaces generated from sweeping a spun tool. A spun silhouette of a spun tool body about a tool spin axis may be generated, which provides a planar sectional profile that would generate a spinning tool body 222. The boundary geometry to be constructed is the envelope of the silhouettes of the spun tool body viewed along a path tangent at each point on a three dimensional (3D) path 240.

The planar sectional profile may be divided into connected elements corresponding to each face or sharp edge on the spun tool. For any position on the 3D path 240, at each point on the section it is possible to calculate a rotation around the tool spin axis that takes it to a silhouette of the tool 224. The same calculation indicates whether a point on the section is not part of the silhouette for the particular path position.

The surfaces generated from the silhouettes may be fitted to arbitrary precision by a non-uniform rational basis spline (NURBS) surface. A general sweeping algorithm produces NURBS surfaces by calculating the positions of appropriate representative points on a profile curve at suitable points along a path. A curve fitted to a silhouette at the position of its “greatest complexity” will generate a sufficient set of representative points. The relationship between the path tangent and the tool spin axis is analyzed to find the key positions of maximum and minimum angle where this greatest complexity occurs. The representative points can be generated either analytically or by fitting, and will typically be small in number.

The locations of these representative points can be efficiently determined at any position on the path by calculating the rotation as above. This only involves solving a quadratic equation for each point, and is substantially faster than performing a general silhouette calculation at a given path position. The number of points that may be needed to represent any portion of the tool is of the same order (and may be the same) as the number of points needed to represent the rotational section of the tool. Cylindrical, spherical, planar and conical faces and sharp edges can typically be represented by a relatively small (two or three) number of points. The overhead of evaluating a quadratic equation for each point is minimal, allowing the shape at any position on the path 240 to be captured efficiently.

Elements of the section that contribute to the silhouette 224 may change as the tool is swept along the path 240 as the angle between the path tangent and the tool spin axis varies. Critical positions 232, 234 on the path where this occurs for a given tool point can be calculated from the sign of the determinant of this same quadratic equation. This allows for robust and rapid division of the path 240 into segments with different composition of tool elements (different model topology). The sweep can be performed independently on each segment and the surfaces combined into a final volume.

To illustrate, the angle between the path tangent and the tool spin axis varies throughout the sweep along path 240, and can be seen to be different at positions 242, 244, and producing different profiles of the spun tool 224. The critical positions 232, 234 on the path indicate points along the path where the composition of the profile of the spun tool changes. The path 240 may be divided into one or more rising, falling, or flat segments. For example, the path 240 may be divided into segments at the critical positions 232, 234. To illustrate, the path 240 may include a first segment 252, a second segment 254 between the critical position 232 and the critical position 234, and a third segment 256. The first segment 252 is illustrated as a falling segment, the second segment 254 is illustrated as a rising segment, and the third segment 256 is illustrated as a falling segment. The path 240 may include additional segments. The sweep may be performed independently on each segment, and a first volume 352 defined by moving the spun tool along the first segment 252 of the path 240 may be determined. Other volumes, such as volumes 354 and 356, may be determined by moving the spun tool along other segments of the path 240 such as by moving the spun tool along the second segment 254 and the third segment 256. A total volume may be determined by adding the other volumes, including the volume 354, to the first volume 352.

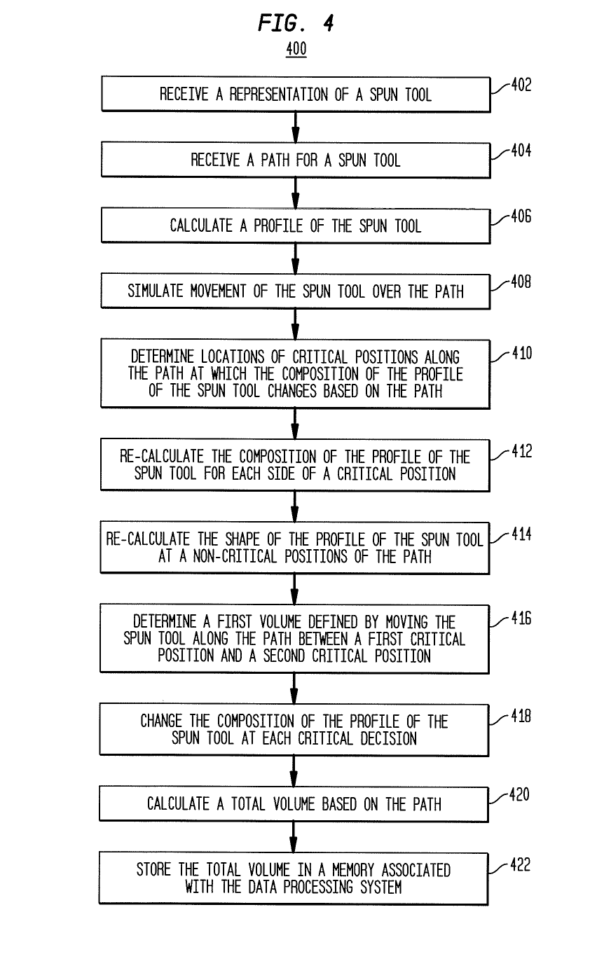

FIG. 4 illustrates a flowchart of a process 400 in accordance with disclosed embodiments that may be performed, for example, by one or more PLM or PDM data processing systems, referred to below as simply the “system.”

The system receives a representation of a spun tool, at step 402, comprising a tool body and an axis of rotation. The system can be the PDM data processing system as described herein, and the representation of the spun tool may be associated with the spun silhouette 222 of FIG. 2. Receiving, as used herein, can include loading from storage, receiving from another device or process, or receiving via an interaction with a user.

The system receives a path for the spun tool, at step 404, and calculates a profile of the spun tool, at step 406. In the example illustrated in FIG. 2, the path is the path 240 of FIG. 2 and the spun tool is the body 222 of FIG. 2.

The system simulates movement of the spun tool over the path, at step 408. This step can be performed in response to a user input.

The system determines critical positions along the path at which the composition of the profile of the spun tool changes based on the path, at step 410, and re-calculates the composition of the profile of the spun tool for each side of a critical position, at step 412. For example, the critical positions 232, 234 on the path of FIG. 2 indicate points along the path where the composition of the profile of the spun tool changes, and the composition of the profile of the spun tool is re-calculated for each side of the critical positions 232, 234.

The system re-calculates the shape of the profile of the spun tool at non-critical positions of the path by solving the quadratic equation for the locations of the representative points, at 414. For example, the shape of the profile of the spun tool may be re-calculated at the positions 242, 244 of FIG. 2.

The system determines a first volume defined by moving the spun tool along the path between a first critical position and a second critical position, at step 416, fitting surfaces to arbitrary precision to the representative points on the profiles calculated at positions along the path. For example, the first volume 352 of FIG. 3 may be defined by moving the spun tool along the path 240 between the critical position 232 and the critical position 234 of FIG. 2.

The system changes the profile of the spun tool at each critical position, at step 418. For example, after re-calculating the composition of the profile for each side of the critical position 232 of FIG. 2, the profile of the spun tool is changed.

The system calculates a total volume based on the path, at step 420. For example, other volumes, such as the volumes 354 and 356 of FIG. 3, may be determined by moving the spun tool along other segments of the path 240, such as by moving the spun tool along the first segment 252 and the third segment 256 of FIG. 2. A total volume may be determined by adding the other volumes 354 and 356 to the first volume 352.

The system stores the total volume in a memory associated with the data processing system, at step 422. For example, the total volume may be stored in the memory 108 of FIG. 1. As part of this step or separately, the system can display total volume to a user or can display a workpiece to a user with the total volume removed from the workpiece.

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method for product data management, the method performed by a data processing system and comprising:
receiving a representation of a spun tool;
receiving a path for the spun tool;
calculating a profile of the spun tool;
simulating movement of the spun tool over the path;
determining, by the data processing system, locations of critical positions along the path at which the composition of the profile of the spun tool changes based on the path;
re-calculating the composition of the profile of the spun tool for each side of a critical position;
re-calculating the shape of the profile of the spun tool at non-critical positions of the path;
determining, by the data processing system, a first volume defined by moving the spun tool along the path between a first critical position and a second critical position;
changing the composition of the profile of the spun tool at each critical position;
calculating, by the data processing system, a total volume based on the path; and
storing the total volume in a memory associated with the data processing system.

2. The method of claim 1, further comprising applying the volume to a work piece to remove portions of the work piece that intersect with the volume.

3. The method of claim 1, wherein the path is a three dimensional path.

4. The method of claim 3, further comprising dividing the path into at least one of a rising section, a falling section, and a flat section.

5. The method of claim 1, wherein determining locations of critical positions along the path is based at least in part on solving a quadratic equation for each critical position.

6. The method of claim 5, wherein determining locations of critical positions along the path is further based at least in part on a sign of a determinant of the quadratic equation.

7. The method of claim 1, further comprising determining the shape of the profile of the spun tool at a position on the path based at least in part on solving a quadratic equation for representative points on the profile of the spun tool at the position on the path.

8. The method of claim 1, wherein calculating the total volume comprises determining other volumes defined by moving the spun tool along the path between other critical positions and adding the other volumes to the first volume.

9. A data processing system comprising:
a processor; and
an accessible memory, the data processing system particularly configured to:
receive a representation of a spun tool;
receive a path for the spun tool;
calculate a profile of the spun tool;
simulate movement of the spun tool over the path;
determine critical positions along the path at which the composition of the profile of the spun tool changes based on the path;
re-calculate the composition of the profile of the spun tool for each side of a critical position;
re-calculate the shape of the profile of the spun tool at non-critical positions of the path;
determine a volume defined by moving the spun tool along the path between a first critical position and a second critical position;
change the composition of the profile of the spun tool at each critical position;
calculate a total volume based on the path; and
store the total volume in a memory associated with the data processing system.

10. The data processing system of claim 9, the data processing system further configured to apply the volume to a work piece to remove portions of the work piece that intersect with the volume.

11. The data processing system of claim 9, wherein the path is a three dimensional path.

12. The data processing system of claim 11, the data processing system further configured to divide the path into at least one of a rising section, a falling section, and a flat section.

13. The data processing system of claim 9, wherein determining locations of critical positions along the path is based at least in part on solving a quadratic equation for each critical position.

14. The data processing system of claim 13, wherein determining locations of critical positions along the path is further based at least in part on a sign of a determinant of the quadratic equation.

15. The data processing system of claim 9, the data processing system further configured to determine the shape of the profile of the spun tool at a position on the path based at least in part on solving a quadratic equation for representative points on the profile of the spun tool at the position on the path.

16. The data processing system of claim 9, wherein calculating the total volume comprises determining other volumes defined by moving the spun tool along the path between other critical positions and adding the other volumes to the first volume.

17. A non-transitory computer-readable medium encoded with executable instructions that, when executed, cause one or more data processing systems to:
receive a representation of a spun tool;
receive a path for the spun tool;
calculate a profile of the spun tool;
simulate movement of the spun tool over the path;
determine critical positions along the path at which the composition of the profile of the spun tool changes based on the path;
re-calculate the composition of the profile of the spun tool for each side of a critical position;
re-calculate the shape of the profile of the spun tool at non-critical positions of the path;
determine a volume defined by moving the spun tool along the path between a first critical position and a second critical position;
change the composition of the profile of the spun tool at each critical position;
calculate a total volume based on the path; and
store the total volume in a memory associated with the data processing system.

18. The computer-readable medium of claim 15, further encoded with computer-executable instructions that, when executed, cause the data processing system to apply the volume to a work piece to remove portions of the work piece that intersect with the volume.

19. The computer-readable medium of claim 17, wherein determining locations of critical positions along the path is based at least in part on solving a quadratic equation for each critical position.

20. The computer-readable medium of claim 19, further encoded with computer-executable instructions that, when executed, cause the data processing system to determine the shape of the profile of the spun tool at a position on the path based at least in part on solving a quadratic equation for representative points on the profile of the spun tool at the position on the path.
